(19) United States
(12) Patent Application Publication
(10) Pub. No.: US 2007/0010028 A1
(43) Pub. Date: Jan. 11, 2007

(54) Chemical solution qualification method, semiconductor device fabrication method, and liquid crystal display manufacturing method

(76) Inventors: Takehiro Kondoh, Yokohama-shi (JP); Hisako Aoyama, Yokohama-shi (JP); Eishi Shiobara, Yokohama-shi (JP); Shinichi Ito, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/475,125

(22) Filed: Jun. 27, 2006

(30) Foreign Application Priority Data
Jun. 29, 2005 (JP) 2005-189949

(51) Int. Cl. G01N 21/00

(52) U.S. Cl. 436/164

(57) ABSTRACT

A method for qualifying a chemical solution is disclosed. This method (a) obtains the number of particles in a chemical solution for each size of the particles, and (b) predicts, for each size of the particles, the influence of the chemical solution on a device to be fabricated by using the chemical solution. The degree of influence of the chemical solution on the device is obtained by using the results of (a) and (b). The quality of the chemical solution is evaluated on the basis of the obtained result, and whether the chemical solution is good or bad is determined on the basis of the evaluation result. On the basis of the determination result, the chemical solution is qualified as a chemical solution for use in a fabrication step of the device.

### CROSS-REFERENCE TO RELATED APPLICATIONS

This application is based upon and claims the benefit of priority from prior Japanese Patent Application No. 2005-189949, filed Jun. 29, 2005, the entire contents of which are incorporated herein by reference.

### BACKGROUND OF THE INVENTION

1. Field of the Invention

The present invention relates to a chemical solution qualification method of evaluating a chemical solution for use in the fabrication of a semiconductor device or in the manufacture of a liquid crystal display, and qualifying the quality of the chemical solution, a semiconductor device fabrication method, and a liquid crystal display manufacturing method.

2. Description of the Related Art

Quality certification of a chemical solution is performed by controlling the size and number of particles in the chemical solution. The size and number of particles are measured (counted) by using a liquid particle counter (Jpn. Pat. Appln. KOKAI Publication No. 9-273987). The liquid particle counter measures the number of particles having sizes falling within a certain range. However, it is very difficult to measure fine particles in a chemical solution. Therefore, not all particles of different sizes in a chemical solution are counted.

Table 1 shows an example of the quality certification of a chemical solution. This table is formed by a resist manufacturer, and shows the quality certification of a resist solution.

TABLE 1

| | | | Permis- | Measured number | | |
|---|---|---|---|---|---|---|
| | | | sible | Lot | Lot | Lot |
| | | | number | number 1 | number 2 | number 3 |
| Size | 0.2-0.3 | μm | 10 | 4 | 9 | 20 |
| | 0.3 | μm | 2 | 1 | 1 | 3 |

| | | | |
|---|---|---|---|
| Solution acceptance/ | Acceptable | Acceptable | Rejectable |
| rejection determination | | | |

Table 1 shows the measured values of the particle counts of three types of resist lots. As shown in Table 1, the quality certification of a chemical solution is done by defining permissible particle counts (permissible numbers) for a plurality of particle size ranges (in Table 1, two ranges, i.e., the range of 0.2 μm (inclusive) to 0.3 μm (exclusive) and the range of 0.3 μm or more). Table 1 shows an example in which ten particles of 0.2 μm (inclusive) to 0.3 μm (exclusive) are permitted, and two particles of 0.3 μm or more are permitted.

The resist manufacturer selects shippable lot numbers on the basis of Table 1. In Table 1, the measured particle counts (measured numbers) of lot numbers 1 and 2 are smaller than the permissible numbers for both the two particle size ranges, but those of lot number 3 are larger than the permissible numbers. Accordingly, the results of solution acceptance/rejection determination are that lot numbers 1 and 2 are acceptable and lot number 3 is to be rejected, so the resist solutions of lot numbers 1 and 2 are shipped.

A user purchases the resist solution found to be acceptable as described above from the resist manufacturer, and forms a resist pattern on a semiconductor substrate or the like. That is, a coating film is formed by coating a wafer with the resist solution, and this coating film is exposed and developed to form a resist pattern.

Even when the resist solution found to be acceptable is used, however, defects on the resist pattern, e.g., defects such as short-circuit defects and aperture defects are not necessarily largely reduced. For example, assume that resist patterns are formed by using the resist solutions of lot numbers 1, 2, and 3 as shown in Table 1, and their defect densities (measurement defect densities) are measured. In this case, the defect densities of the resist patterns formed by using the resist solutions of lot numbers 1 and 3 are smaller than a permissible defect density (wafer acceptance/rejection determination is acceptable) in some cases, whereas the defect density of the resist pattern formed by using the resist solution of lot number 2 exceeds the permissible defect density (wafer acceptance/rejection determination is rejectable). That is, lot number 2 which is found to be acceptable by the resist manufacturer is found to be a reject by the user, so the results of determination by the two do not match.

As in this example, if a lot number found to be acceptable by solution acceptance/rejection determination by the resist manufacturer does not match a lot number found to be acceptable by wafer acceptance/rejection determination by the user, a large compensation occurs on the resist manufacturer side, and a large loss occurs on the user side. The same problem can arise for other chemical solutions such as a low-k-material-containing solution and ferroelectric-material-containing solution.

Note that Jpn. Pat. Appln. KOKAI Publication No. 6-148057 discloses a method of increasing the measurement accuracy by performing correction by taking account of the optical refractive indices of actual sample solutions and fine particles in a liquid fine particle measurement apparatus which irradiates a measurement sample of a chemical solution with a laser beam, and measures the pulses of the scattered light from foreign particles in the chemical solution by a light-receiving element.

Note also that Jpn. Pat. Appln. KOKAI Publication No. 7-120376 discloses a method capable of high-accuracy measurement by selecting measurement light which does not belong to the light absorption band of a measurement sample, when measuring the particle diameter and number of fine particles in a liquid sample such as a photoresist by irradiating a flow path of the sample with measurement light and measuring the scattered light.

As described earlier, when the number of particles in a chemical solution is measured for each size by a liquid particle counter and quality control is performed by using the result, measurable particle sizes are limited (presently, 0.15 μm or more), so it is impossible to measure the number of fine particles (e.g., 0.1 to 0.15 μm) which must be controlled for actual device fabrication. Therefore, defects on a resist pattern are not necessarily largely reduced even when a resist solution found to be acceptable by the resist manufacturer is used probably because the solution contains particles less than 0.2 μm, i.e., fine particles exceeding the measurement limit (minimum measurable fine particle diameter) of a measurement apparatus (counter) such as a chemical solution particle counter.

To solve this problem, the present applicant filed in Japan a chemical solution qualification method capable of accurately qualifying the quality of a chemical solution by predicting, by using a predetermined function, fine particles which are difficult to measure by a liquid particle counter, and a semiconductor device fabrication method capable of performing a process by using a high-quality chemical solution (Japanese Patent Application No. 2004-119363 (Jpn. Pat. Appln. KOKAI Publication No. 2005-300421)). This application was filed Apr. 14, 2005, in U.S.A. (U.S. patent application Ser. No. 11/105,362).

A chemical solution qualification method of a first aspect according to Japanese Patent Application No. 2004-119363 (Jpn. Pat. Appln. KOKAI Publication No. 2005-300421) is characterized by comprising a step of obtaining, by measurement, the number of particles in a liquid for each size of the particles, a step of expressing, by a function, the relationship between the size of particles in the liquid and the number of particles corresponding to the size, on the basis of the number of particles obtained by the measurement for each size of the particles, a step of evaluating, on the basis of the function, the influence of particles contained in the liquid and having a size smaller than a measurement limit, thereby determining whether the liquid is good or bad, and a step of qualifying the liquid as a chemical solution if the liquid is found to be good in the step of determining whether the liquid is good or bad.

Also, a chemical solution qualification method of a second aspect according to Japanese Patent Application No. 2004-119363 (Jpn. Pat. Appln. KOKAI Publication No. 2005-300421) is characterized by comprising a step of obtaining the number of particles in a liquid for each size of the particles by using a liquid particle counter, a function expression step of expressing the relationship between the size of the fine particles and the number of particles corresponding to the size, by using an exponential function or power function, a comparison step of comparing at least one of the coefficient of the exponential function and the power of the power function with a predetermined value, and a qualification step of qualifying the liquid as a chemical solution for use in a predetermined semiconductor fabrication step, if the coefficient or power is smaller than the predetermined value in the comparison step.

The kind of impact that is given to a device by a chemical solution which is quality-controlled by using the results of measurements of the size and number of particles in the chemical solution performed by using a liquid particle counter is unknown. Also, the invention according to Japanese Patent Application No. 2004-119363 (Jpn. Pat. Appln. KOKAI Publication No. 2005-300421) does not describe any practical determination criterion for a chemical solution, so the kind of impact that is given to a device by a chemical solution controlled by the method of the invention is unknown.

On the other hand, in actual particle control, it is necessary not only to predict and control the number of fine particles, but also to reduce relatively large particles as close to zero as possible. Accordingly, it is unsatisfactory to predict and control the number of fine particles by expressing the size and number of particles by a function.

### BRIEF SUMMARY OF THE INVENTION

A method for qualifying a chemical solution according to a first aspect of the present invention comprises: (a) obtaining the number of particles in a chemical solution for each size of the particles; (b) predicting, for each size of the particles, influence of the chemical solution on a device to be fabricated by using the chemical solution; and (c) obtaining a degree of influence of the chemical solution on the device by using results of (a) and (b), evaluating quality of the chemical solution on the basis of an obtained result, determining whether the chemical solution is good or bad on the basis of an evaluation result, and qualifying the chemical solution as a chemical solution for use in a fabrication step of the device on the basis of a determination result.

A method for manufacturing a semiconductor device according to a second aspect of the present invention comprises: qualifying a chemical solution for use in manufacture of a semiconductor device by using a qualification method described in the first aspect of the present invention; and manufacturing the semiconductor device by using the qualified chemical solution.

A method for manufacturing a liquid crystal display according to a third aspect of the present invention comprises: qualifying a chemical solution for use in the manufacture of a liquid crystal display by using a qualification method described in the first aspect of the present invention; and manufacturing the liquid crystal display by using the qualified chemical solution.

### BRIEF DESCRIPTION OF THE SEVERAL VIEWS OF THE DRAWING

FIG. 1 is a graph showing an example of the result of the measurement, performed by a liquid particle counter, of the relationship between the size and number of particles in a resist solution used in the fabrication of a semiconductor device;

FIG. 2 is a graph showing the result of the calculation of an area having influence on a semiconductor device as a function of the particle diameter of particles;

FIG. 3 is a graph showing the area having influence on a device by superposing the graphs shown in FIGS. 1 and 2;

FIG. 4 is a graph showing the result of fitting performed by values measured by a liquid particle counter and a power function;

FIG. 5 is a graph showing the area having influence on a device by superposing the result of the calculation of the area having influence on a semiconductor device as a function of the particle diameter of particles shown in FIG. 2, and the result shown in FIG. 4;

FIG. 6 is a flowchart showing an example of a quality control method using a chemical solution qualification method of the third embodiment;

FIGS. 7A to 7D are sectional views showing a first example of a semiconductor device fabrication method;

FIGS. 8A to 8C are sectional views showing a second example of the semiconductor device fabrication method;

FIGS. 9A to 9C are sectional views showing a third example of the semiconductor device fabrication method;

FIGS. 10A to 10C are sectional views showing a fourth example of the semiconductor device fabrication method;

FIGS. 11A and 11B are sectional views showing a fifth example of the semiconductor device fabrication method; and

FIGS. 12A and 12B are sectional views showing a sixth example of the semiconductor device fabrication method.

### DETAILED DESCRIPTION OF THE INVENTION

Embodiments of the present invention will be described below with reference to the views of the accompanying drawing.

### First Embodiment

A chemical solution qualification method of this embodiment comprises a step of obtaining, by measurement, the number of particles in a chemical solution for each size (particle diameter) of the particles, a step of predicting, for each size of the particles, the degree of influence of the chemical solution on a semiconductor device to be fabricated by using the chemical solution, and a step of calculating the influence of the chemical solution on the semiconductor device by using the results in the above two steps, evaluating the quality of the chemical solution, determining whether the chemical solution is good or bad on the basis of the evaluation result, and qualifying the chemical solution as a chemical solution for use in a predetermined semiconductor fabrication step.

A practical example of this embodiment will be described below.

FIG. 1 shows an example of the result of the measurement, performed by using, e.g., a liquid particle counter, of the number of particles (particle count) for each size (particle diameter, particle size) of particles in an ArF-light chemical amplification resist solution for use in photolithography or the like. More specifically, FIG. 1 shows the result of the measurement of the number of fine particles for each particle size having a certain width, e.g., a width of 0.15 to 0.17 μm or 0.17 to 0.19 μm.

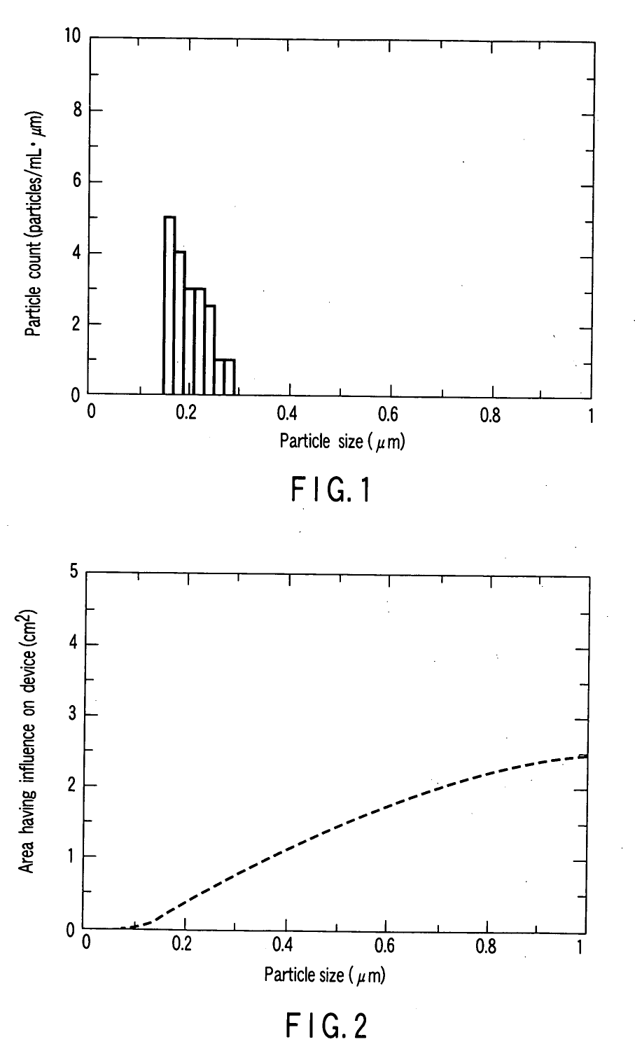

FIG. 2 is a graph showing the result of the calculation of a device area in which particles have influence on the surroundings as a function of the particle diameter of the particles, when the particles exist in a resist pattern formed on a semiconductor wafer during the fabrication of a semiconductor device.

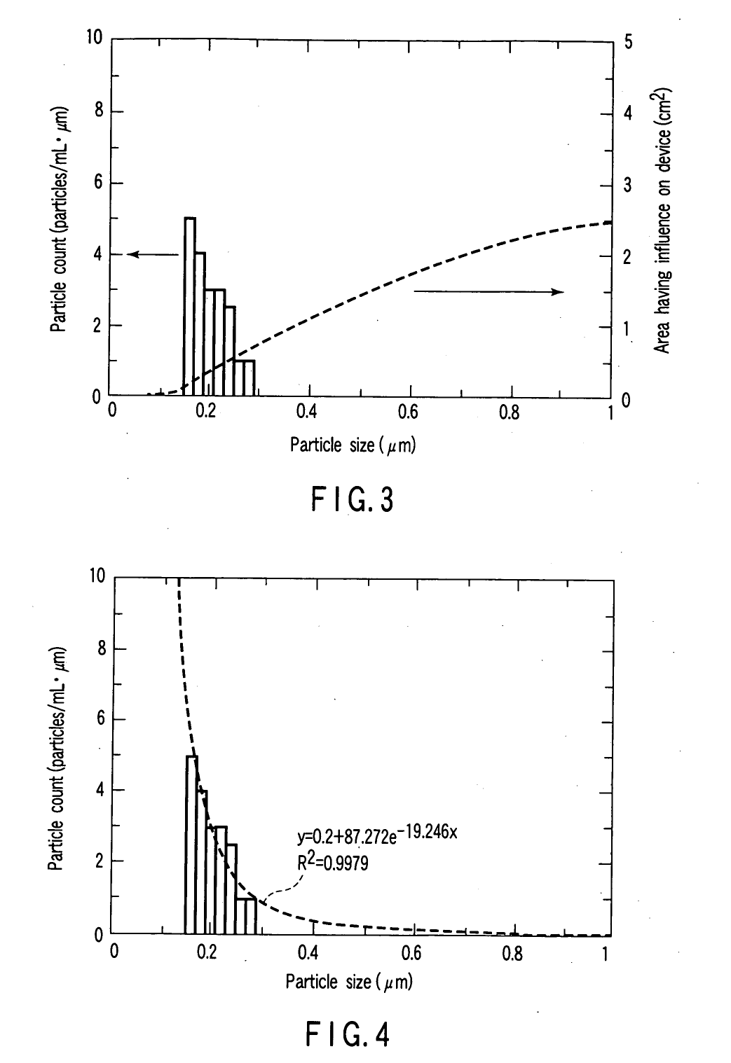

FIG. 3 shows the result of the superposition of the graphs shown in FIGS. 1 and 2. Then, the two results shown in FIGS. 1 and 2 are integrated by
I=∫F(x)G(x)dx (1)
where x is the particle diameter, F(x) is the number of particles having the particle diameter x, G(x) is the area in which the particles having the particle size x has influence on a device, and I is the degree of influence (predicted value) of the chemical solution on the device. The degree of influence I in this example is the sum total value of areas in which all the particles in the chemical solution have influence on the semiconductor device.

The integration range of equation (1) stretches from a particle size of 0 μm or the detection limiting value (in this example, 0.15 μm) of the liquid particle counter to the maximum value (in this example, 0.28 μm) of the particle size.

When a calculation is performed by using the superposition result shown in FIG. 3 and equation (1), the result is 0.15228 cm². This value is smaller than the 0.2 cm² permitted for the device for which the chemical solution to be evaluated this time is used, so the chemical solution evaluated this time is acceptable.

As described above, the chemical solution qualification method of this embodiment can accurately qualify whether a chemical solution is good or bad by weighting the result of the measurement of the chemical solution performed by a liquid particle counter by the impact given to a device (i.e., by adding the degree of influence which particles in the chemical solution have on the device). Consequently, it is possible to implement a semiconductor device fabrication method by which the degree of influence of a chemical solution on a device can be confined within an allowable range by performing a process using a high-quality chemical solution thus qualified.

### Second Embodiment

A chemical solution qualification method of this embodiment comprises a step of obtaining, by measurement, the number of particles in a chemical solution for each size of the particles by using a liquid particle counter, a function expression step of expressing the relationship between the size of particles in the chemical solution and the number of particles corresponding to the size by using a function (e.g., an exponential function or power function), on the basis of the number of particles of each size of the particles obtained by the measurement, a step of predicting, for each size of the particles, the degree of influence which the chemical solution has on a semiconductor device to be fabricated by using the chemical solution, and a step of calculating the influence of the chemical solution on the semiconductor device by using the results in the above two steps, evaluating the quality of the chemical solution, determining whether the chemical solution is good or bad on the basis of the evaluation result, and qualifying the chemical solution as a chemical solution for use in a predetermined semiconductor fabrication step.

The method may further comprise, after the function expression step, a comparison step of comparing at least one of the coefficient of the exponential function and the power of the power function with a predetermined value, and, if the coefficient or power is smaller than the predetermined value in the comparison step, may qualify the chemical solution as a chemical solution for use in a predetermined semiconductor fabrication step.

A practical example of this embodiment will be explained below.

First, as in the first embodiment, the relationship between the size and number of fine particles in an ArF-light chemical amplification resist solution for use in photolithography is obtained by using a liquid particle counter (e.g., FIG. 1).

Then, as shown in FIG. 4, fitting is performed by “an exponential function or power function” by using the measurement result. FIG. 4 shows the result of measurement of the number of particles with respect to the size of particles in the resist solution performed by the liquid particle counter, and the result of prediction of the number of fine particles smaller than a minimum measurable fine particle diameter performed by fitting the measurement result by “the exponential function”. Referring to FIG. 4, the broken line indicates the exponential function which represents the relationship between the particle size and particle count including the prediction result. The exponential function y is indicated by
y=y₀+Ae^{-Xα}
y=0.2+87.272e^{-19.246X} (2)
wherein y is the number of particles, X is the size of particles, yₒ is offset, A is a coefficient (modulus), e is the exponential, and α is the power.

The power of the resist solution is α=19.246. In this case, a correlation coefficient is R²=0.9979, i.e., the fitting accuracy is very high. Note that in this fitting, the coefficient A=87.272 in equation (2) may also be appropriately changed such that R² is 0.99. This is equivalent to an operation of performing baseline correction on liquid particles.

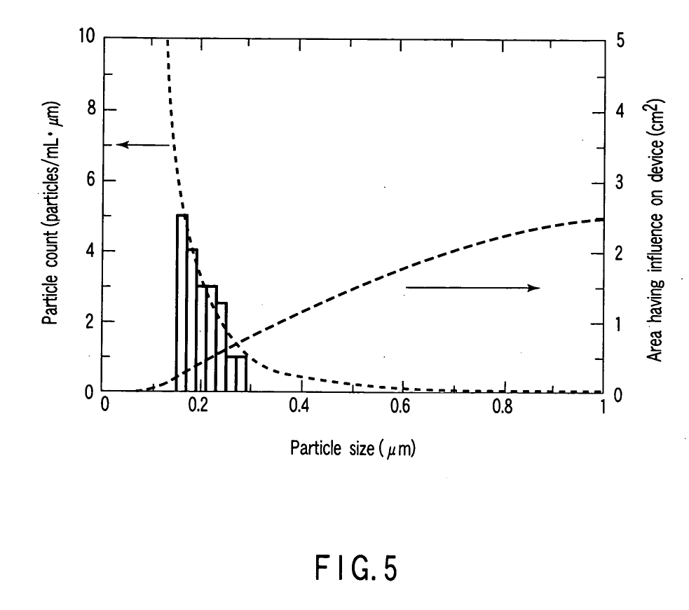

Subsequently, as in the first embodiment, the result (the same result as shown in FIG. 2) of the calculation of an area having influence on the device as a function of the particle diameter and the result shown in FIG. 4 are superposed. FIG. 5 shows the result of the superposition. The two results shown in FIG. 5 are integrated. Note that the integration range extends from 0 μm, because the smallest particle diameter is smaller than the measurement limit of the liquid particle counter, to 0.28 μm which is the size of the largest particle detected by the liquid particle counter. More specifically, the integration calculation indicated by equation (1) is performed.

When the two results shown in FIG. 5 are integrated by equation (1) as described above, the result is 0.2161 cm². This value is smaller than 0.25 cm² permitted for a device to be fabricated by using the chemical solution to be evaluated this time, so the chemical solution evaluated this time is acceptable.

In the chemical solution qualification method of this embodiment described above, whether a chemical solution is good or bad is not determined on the basis of the number of fine particles having a specific size, but the number of fine particles is first represented by the exponential function or power function of the fine particle size, thereby predicting the numbers of particles from a very small size to a large size. In addition, the influence of the chemical solution on a device is calculated by using the result expressed by the function and the result of prediction, performed for each size of the particles, of the degree of influence of the chemical solution on the device, thereby evaluating the quality of the chemical solution.

Note that in this embodiment, the relationship between the size of particles in a chemical solution and the number of particles corresponding to the size is fitted by using an exponential function. However, this relationship may also be fitted by using a power function. An example of the power function is:
y=y₀+AX^{-α}
where y is the number of particles, X is the size of particles, yₒ is offset, A is a coefficient (modulus), and α is the power.

Note that examples of the exponential function and power function are also described in U.S. patent application Ser. No. 11/105,362, the entire contents of this reference are incorporated herein by reference.

The liquid particle counter used in this embodiment is not particularly limited as long as the counter can measure fine particles in a liquid. For example, the liquid particle counter can include any mechanism such as a mechanism which performs calculations by an analyzing method based on the detection of Mie scattering, or a mechanism which performs calculations by an analyzing method using the Doppler effect.

### Third Embodiment

A chemical solution qualification method of this embodiment is characterized by comprising a step of obtaining, by measurement, the number of particles in a chemical solution for each size (particle size) of the particles, a step of expressing, by using a function, the relationship between the size of particles in the chemical solution and the number of particles corresponding to the size, on the basis of the number of particles measured for each size of the particles, and a step of controlling the degree of influence of the chemical solution on a semiconductor device to be fabricated by using the chemical solution, such that the influence of fine particles having influence on device fabrication and having sizes equal to or smaller than the measurement limit is predicted and controlled for each size of the particles on the basis of the function, and relatively large ones of particles in a measurable region are controlled by at least one fixed value in order to control the stability of a chemical solution manufacturing line, thereby evaluating the quality of the chemical solution, determining whether the chemical solution is good or bad on the basis of the evaluation result, and qualifying the chemical solution as a chemical solution for use in a predetermined semiconductor fabrication step.

A practical example of this embodiment will be explained below.

First, as in the first embodiment, the sizes and numbers of particles in an ArF chemical amplification resist for use in photolithography are measured by using a liquid particle counter. The minimum particle size measurable by the liquid particle counter is presently 0.15 μm. The measurement results are more specifically obtained as total values, e.g., the number of particles having a size of 0.15 μm or more, the number of particles having a size of 0.18 μm or more, . . . , of particles in 10 ml of a solution. When a prediction method using a function is applied to fine particles which are difficult to measure by the liquid particle counter, the relationship between the size (x) and number (y) of particles can be approximated to y=axⁿ by processing data at an interval of 0.01 μm. For example, y=0.0051x^{-6.3884}, and R²=0.998.

This relationship is presumably caused by the type of material of a chemical solution filter and the mesh size of the chemical solution filter, and indicates that the number of large particles increases when the number of small particles decreases, and the number of small particles increases when the number of large particles decreases. In actual particle control, it is necessary not only to predict and control the number of fine particles, but also to decrease the number of relatively large particles as close to zero as possible. Therefore, it is unsatisfactory to predict and control the number of fine particles by expressing the size and number of particles by a function.

For example, a particle size which must be controlled for a 65-nm-generation device is 0.1 μm or more, and a particle size which must be controlled for a 45-nm-generation device is 0.08 μm or more. To reduce the number of fine particles, a constant n need only be increased. For a 65-nm-generation device, for example, relatively large particles of 0.25 μm or more which can be readily removed in a resist fabrication process are controlled by a fixed value n of, e.g., 3 particles/10 ml or less, and particles of 0.1 μm or more which have impact on the device yield and particles of less than 0.25 μm which are not controlled by a fixed value are predicted by a function derived from the measured values of 0.15 to 0.25 μm, and controlled by a value equal to or larger than the control value n for obtaining the necessary yield.

Assuming that an allowable aperture defect count is 0.05 defects/cm² in contact hole formation, the control value n for obtaining the necessary yield is determined from the result of defect evaluation using a prepared test mask. The aperture defect count increases when the number of relatively large particles is large, even if the value of n is achieved. Also, the stability of the chemical solution manufacturing line can be checked by monitoring the number of relatively large particles. If the number of relatively large particles increases, the inconvenience of the manufacturing line must be investigated.

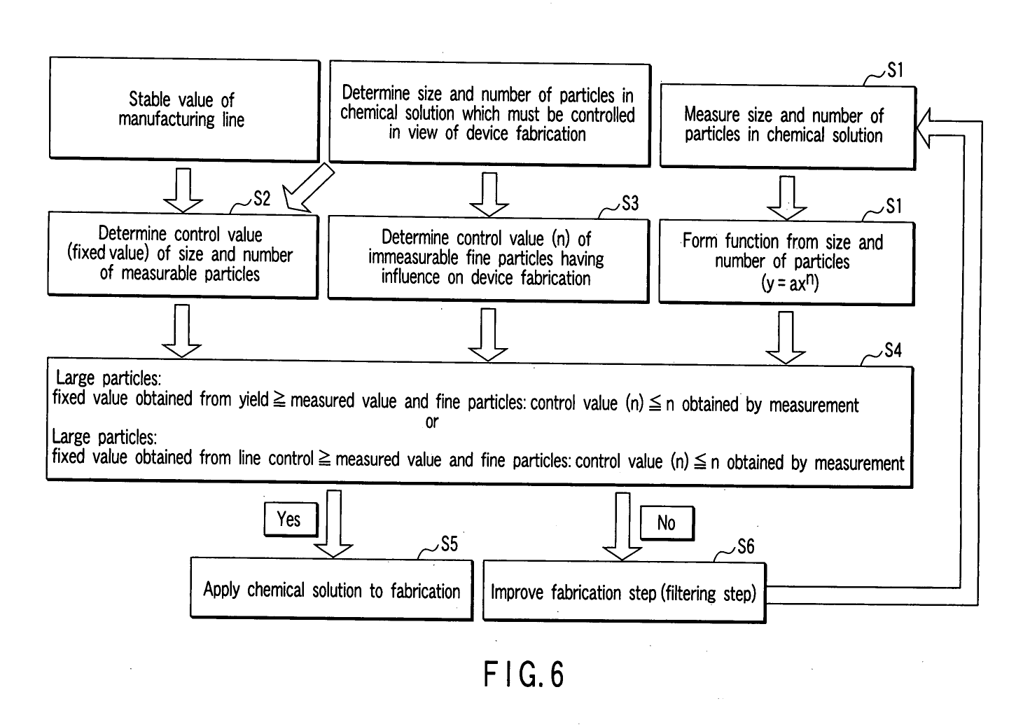

FIG. 6 is a flowchart showing an example of a quality control method using the chemical solution qualification method of the third embodiment. This control shown in FIG. 6 can be control by an operator, control using a computer, or control combining the both.

First, the size and number of particles in a chemical solution are measured using, e.g., a liquid particle counter, and the relationship between the size and number of particles is represented by a function (in this case, y=axⁿ where y: the number of particles, x: the size of particles, a: a constant, and n: a constant) (step S1).

The size and number of particles in the chemical solution which must be controlled from the viewpoint of device fabrication can be calculated from the necessary yield (step S2). On the other hand, immeasurable fine particles having influence on device fabrication are controlled by the value of n of y=axⁿ (step S3). Measurable relatively large particles are controlled by using the value of n obtained by measurement as a fixed value (step S4). If a value normally obtained in the chemical solution manufacturing step is smaller than the value of n obtained by measurement, it is desirable to use this normally obtained value as a fixed value (step S4) in order to monitor the stability of the chemical solution manufacturing line.

If the value of n is achieved, the chemical solution is qualified as applicable to device fabrication (step S5). If the value of n is not achieved, some improvement is performed, i.e., a filter having higher performance is applied, or filtering is performed after relatively large particles are removed, in order to supply a stable solution to device fabrication (step S6).

In the chemical solution qualification method of the third embodiment described above, fine particles in a chemical solution which have influence on a semiconductor device to be fabricated by using the chemical solution are predicted and controlled by representing, by a function, the size and number of particles which can be measured by a liquid particle counter, and measurable relatively large particles are controlled by at least one fixed value. In this manner, a quality-certified chemical solution can be provided to device fabrication.

Note that in the chemical solution qualification method of the third embodiment described above, the fixed value n is not limited to a number which must be controlled from the viewpoint of device fabrication. If a number normally obtained in the chemical solution manufacturing step is smaller than the number which must be controlled in view of device fabrication, this number normally obtained in the chemical solution manufacturing step can be used as the fixed value n. That is, as the fixed value n, it is possible to use a smaller one of the number which must be controlled in view of device fabrication, and the number normally obtained in the chemical solution manufacturing step.

Note that the power function is taken as an example of a function in the third embodiment, but an exponential function may also be used. The power exponent of the exponential function need only be controlled in this case as well.

### Fourth Embodiment

A semiconductor device fabrication method using a chemical solution which is quality-controlled and qualified by the present invention will be explained below. The semiconductor device fabrication method of this embodiment comprises a step of coating-a substrate to be processed with a chemical solution qualified by one of the first to third embodiments, and a step of performing predetermined processing on the chemical solution applied on the substrate.

Also, the semiconductor device fabrication method of this embodiment comprises a step of forming a resist coating film by coating a wafer (substrate to be processed) with a resist solution which is qualified as a chemical solution by one of the first to third embodiments, a step of selectively exposing a portion of the resist film, and a step of forming a resist pattern by developing the resist film having the selectively exposed portion. In the step of forming a resist pattern by developing the resist film having the selectively exposed portion, the resist pattern is formed by removing the selectively exposed portion or a selectively unexposed portion of the resist film.

A practical example of this embodiment will be described below with reference to the views of the accompanying drawing.

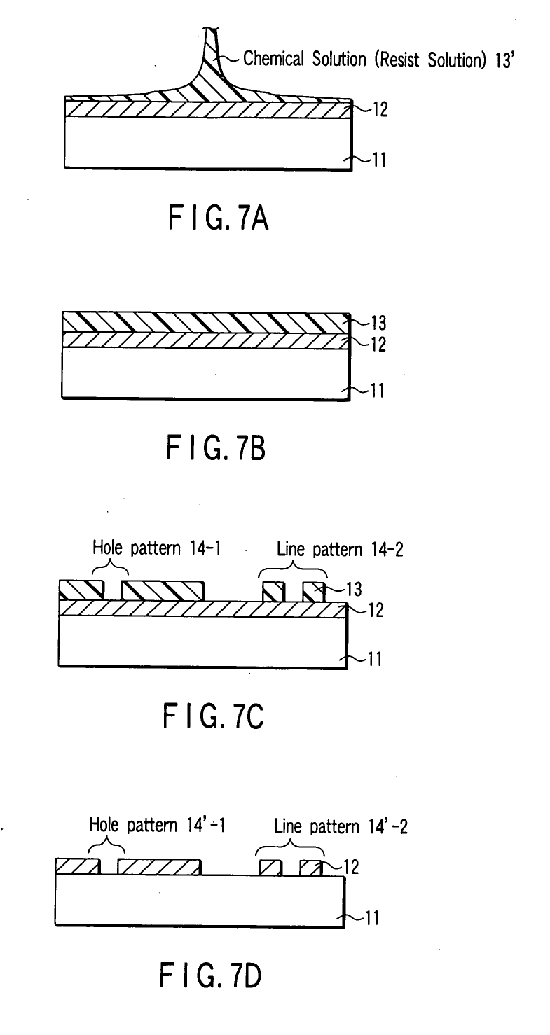

First, as shown in FIG. 7A, a wafer 11 on which an undercoating structure 12 (in this example, a conductive film) is preformed is coated with a resist solution 13′ which is qualified by one of the first to third embodiments by the conventional resist coating step. Then, the resist solution 13′ is set to form a resist film 13.

Subsequently, as shown in FIG. 7B, a necessary mask is used to form desired resist patterns 14-1 and 14-2 on the resist film 13 by the conventional exposure step and development step. In this example, the resist pattern 14-1 is a hole pattern, and the resist pattern 14-2 is a line pattern.

As shown in FIG. 7C, a step of etching the undercoating structure 12 and a step of removing the resist film 13 are performed to form desired patterns in the undercoating structure 12. In this example, a hole pattern 14′-1 and line pattern 14′-2 are formed in the undercoating structure 12.

In the semiconductor device fabrication method of this embodiment described above, the number of particles mixed in the resist solution is equal to or smaller than a standard for achieving a certain yield. This makes it possible to reduce line short-circuits of a line pattern (e.g., an interconnection pattern), and reduce defective apertures of a hole pattern (e.g., a contact hole pattern), thereby improving the reliability of the device. That is, resist patterns can be formed with almost no short-circuits (resist pattern connections) and almost no defective apertures. In addition, it is possible to greatly increase the reliability of an insulating film for processing the resist patterns into a mask and the reliability of interconnections.

As light (exposure light) used to expose the resist film 13, it is possible to use, e.g., X rays such as ultraviolet (UV) radiation, deep-ultraviolet (DUV) radiation, vacuum ultraviolet (VUV) radiation, or EUV, or a charged particle beam such as an electron beam or ion beam. The resist solution 13′ for forming the resist film 13 may also be any solution as long as it is sensitive to the exposure light. The resist film 13 can be removed by, e.g., wet development using an alkali developer or organic developer, or etching using reactive ions.

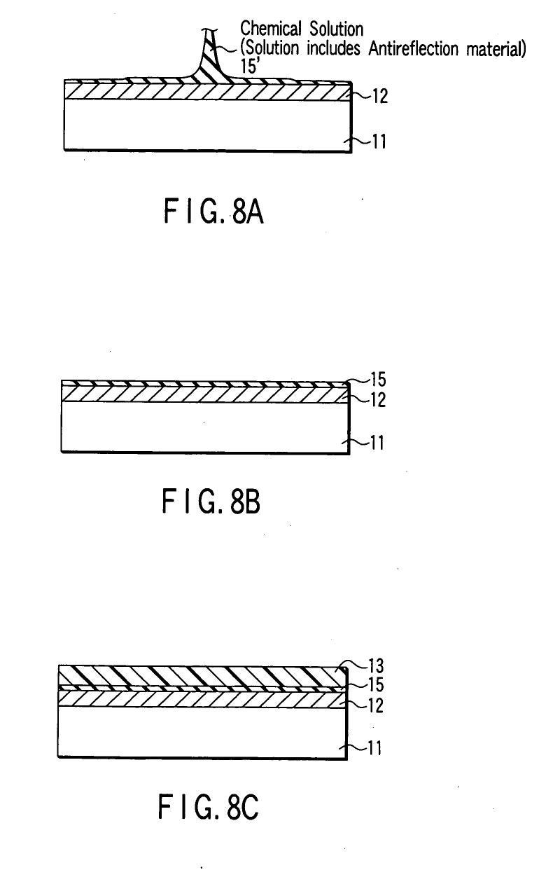

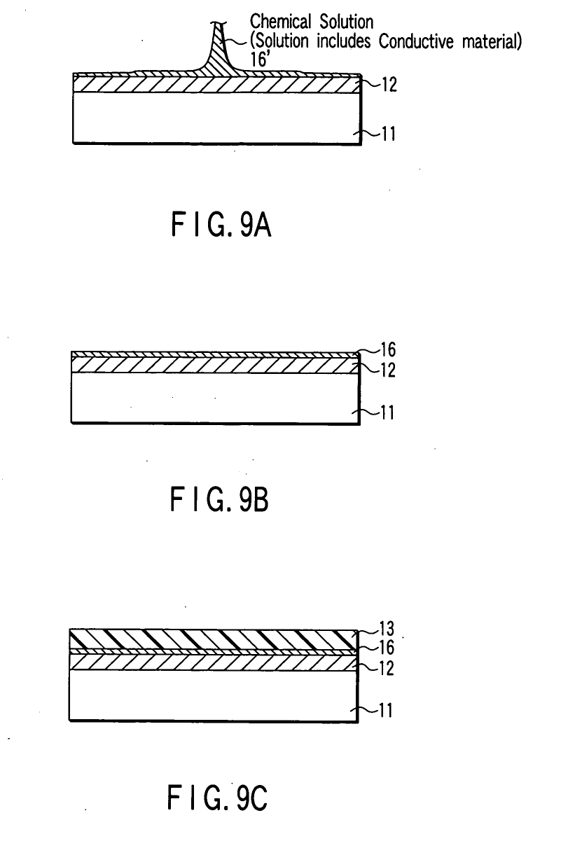

When an antireflection film 15 is to be formed between the resist film 13 and the wafer (in this example, the undercoating structure 12) as shown in FIGS. 8A to 8C, or when a conductive film 16 is to be formed between the resist film 13 and the wafer (in this example, the undercoating structure 12) as shown in FIGS. 9A to 9C, a chemical solution qualified by one of the first to third embodiments is desirably used as a solution 15′ containing an antireflection material or a solution 16′ containing a conductive material. Likewise, although not shown, when the antireflection film 15 or conductive film 16 is to be formed on the resist film 13, a chemical solution qualified by one of the first to third embodiments is desirably used as the solution 15′ containing an antireflection material or the solution 16′ containing a conductive material.

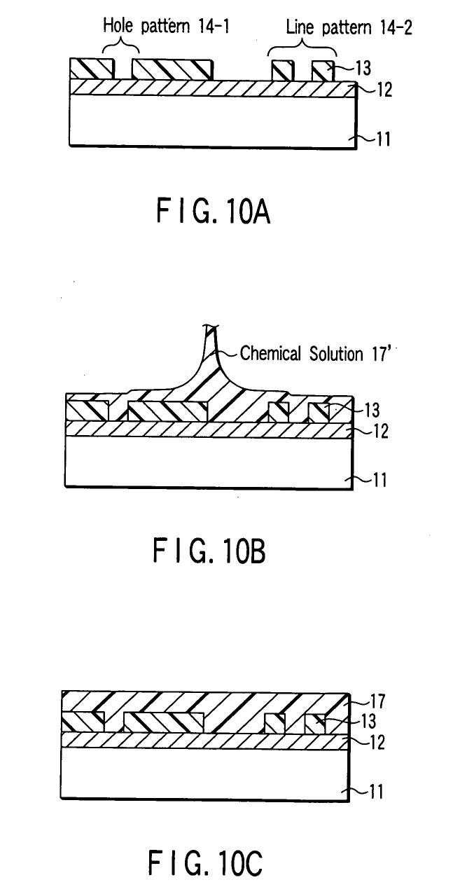

Also, as shown in FIGS. 10A to 10C, when a second coating film 17 is to be formed on the resist patterns (in this example, the hole pattern 14-1 and line pattern 14-2), a chemical solution qualified by one of the first to third embodiments is desirably used as a solution 17′ containing a second coating film material.

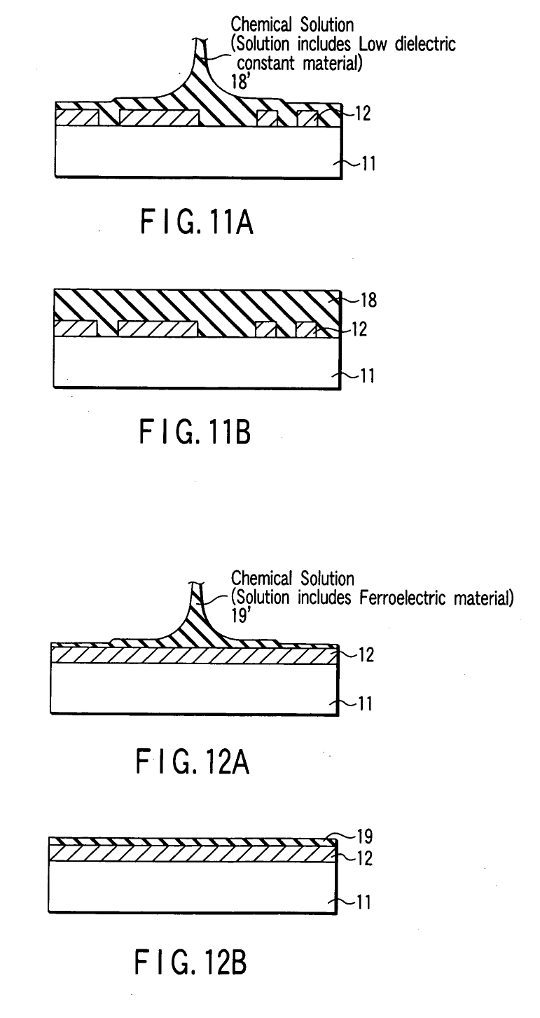

Furthermore, when a low-dielectric-constant film 18 is to be formed by application of a solution 18′ containing a low-dielectric-constant material as shown in FIGS. 11A and 11B, or when a ferroelectric film 19 is to be formed by application of a solution 19′ containing a ferroelectric material as shown in FIGS. 12A and 12B, a chemical solution qualified by one of the first to third embodiments can be used.

Note that the present invention is not limited to the above embodiments. For example, the substrate to be processed is a wafer in the above embodiments, but another substrate such as a glass substrate may also be used. When the substrate to be processed is a glass substrate, a semiconductor device fabrication method is, e.g., a liquid crystal display (LCD) manufacturing method.

The above embodiments can realize a chemical solution qualification method capable of accurately qualifying whether a chemical solution is good or bad by adding the degree of influence which particles in the chemical solution have on a device to be fabricated by using the chemical solution, and a semiconductor device fabrication method or liquid crystal display manufacturing method by which the degree of influence of a chemical solution on a device can be confined within an allowable range by performing a process using a high-quality chemical solution qualified by the above chemical solution qualification method.

Also, above embodiments can provide a chemical solution qualification method capable of accurately qualifying whether a chemical solution is good or bad by adding the degree of influence which relatively large particles in the chemical solution have on a device to be fabricated by using the chemical solution, and a semiconductor device fabrication method or liquid crystal display manufacturing method by which the degree of influence of a chemical solution on a device can be confined within an allowable range by performing a process using a high-quality chemical solution qualified by the above chemical solution qualification method.

Consequently, it is possible to secure the yield necessary for device fabrication and control the stability of the chemical solution manufacturing line.

In addition, the present invention is not directly limited to the above embodiments, and can be embodied by modifying the constituent elements without departing from the spirit and scope of the invention when practiced. Also, various inventions can be formed by appropriately combining a plurality of constituent elements disclosed in the embodiments. For example, some of all the constituent elements disclosed in the embodiments may also be deleted. Furthermore, constituent elements of different embodiments may also be appropriately combined. That is, the present invention can be variously modified without departing from the spirit and scope of the invention when practiced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for qualifying a chemical solution, comprising:
(a) obtaining the number of particles in a chemical solution for each size of the particles;
(b) predicting, for each size of the particles, influence of the chemical solution on a device to be fabricated by using the chemical solution; and
(c) obtaining a degree of influence of the chemical solution on the device by using results of (a) and (b), evaluating quality of the chemical solution on the basis of an obtained result, determining whether the chemical solution is good or bad on the basis of an evaluation result, and qualifying the chemical solution as a chemical solution for use in a fabrication step of the device on the basis of a determination result.

2. A method according to claim 1, wherein the influence of the chemical solution on the device is predicted by obtaining, for each size of the particles, an area in which the particles in the chemical solution have influence on the device.

3. A method according to claim 1, wherein
the size of the particles is a particle diameter of the particles, and
the number of particles of each size of the particles is obtained for each particle diameter by measuring particle diameters of the particles by using a liquid particle counter.

4. A method according to claim 2, wherein
the size of the particles is a particle diameter of the particles,
the number of particles of each size of the particles is obtained for each particle diameter by measuring particle diameters of the particles by using a liquid particle counter, and
the area which is obtained for each size of the particles and in which the particles have influence on the device is obtained for each particle diameter of the particles.

5. A method according to claim 4, wherein the degree of influence of the chemical solution on the device is calculated on the basis of the number of particles of each particle diameter, and the area which is obtained for each particle diameter and in which the particles have influence on the device.

6. A method according to claim 5, wherein a degree of influence I of the chemical solution on the device is calculated by
I=∫f(x)G(x)dx
where F(x) is the number of particles having a particle diameter x, G(x) is an area in which the particles having the particle diameter x have influence on the device, and an integration range stretches from one of a particle diameter of 0 and a measurement limiting value of the liquid particle counter to a maximum value of the particle diameter.

7. A method according to claim 1, wherein
the size of the particles is a particle diameter of the particles, and
the number of particles of each size of the particles is obtained by measuring particle diameters of the particles by using a liquid particle counter, and fitting a measurement result by a function.

8. A method according to claim 2, wherein
the size of the particles is a particle diameter of the particles,
the number of particles of each size of the particles is obtained by measuring particle diameters of the particles by using a liquid particle counter, and fitting a measurement result by a function, and
the area which is obtained for each size of the particles and in which the particles have influence on the device is obtained for each particle diameter of the particles.

9. A method according to claim 8, wherein a degree of influence of the chemical solution on the device is calculated on the basis of the function used in the fitting, and the area which is obtained for each particle diameter and in which the particles have influence on the device.

10. A method according to claim 9, wherein a degree of influence I of the chemical solution on the device is calculated by
I=∫F(x)G(x)dx
where F(x) is the function used in the fitting, G(x) is an area in which the particles having a particle diameter x have influence on the device, and an integration range stretches from one of a particle diameter of 0 and a measurement limiting value of the liquid particle counter to a maximum value of the particle diameter.

11. A method according to claim 10, wherein the function is one of an exponential function and a power function.

12. A method according to claim 7, wherein of the particles in the chemical solution, the number of particles not more than a measurement limit value of the liquid particle counter is predicted and controlled on the basis of the function.

13. A method according to claim 12, wherein the function is one of an exponential function and a power function.

14. A method according to claim 13, wherein of the particles in the chemical solution, the number of particles having a particle diameter which must be controlled in view of fabrication of the device is measured and controlled on the basis of one of a value obtained by measurement by the liquid particle counter, and a value obtained in a manufacturing step of the chemical solution.

15. A method according to claim 14, wherein
the number of particles not more than a measurement limiting value of the liquid particle counter is controlled by a power of one of the exponential function and the power function, and
the number of particles having a particle diameter which must be controlled in view of fabrication of the device is controlled by one of a yield and a fixed value obtained by line control.

16. A method according to claim 15, wherein
a degree of influence of the chemical solution on the device is obtained on the basis of
whether the power is not less than a control value, and
whether one of the value obtained by measurement by the liquid particle counter and the value obtained in the manufacturing step of the chemical solution is not more than the fixed value.

17. A method according to claim 16, wherein manufacture of the chemical solution is applied if the power exceeds the control value, and one of the value obtained by measurement by the liquid particle counter and the value obtained in the manufacturing step of the chemical solution is less than the fixed value.

18. A method according to claim 16, wherein manufacture of the chemical solution is improved if at least one of conditions that the power is not more than the control value, and that one of the value obtained by measurement by the liquid particle counter and the value obtained in the manufacturing step of the chemical solution is not less than the fixed value, is satisfied.

19. A method for manufacturing a semiconductor device, comprising:
qualifying a chemical solution for use in manufacture of a semiconductor device by using a qualification method cited in claim 1; and
manufacturing the semiconductor device by using the qualified chemical solution.

20. A method for manufacturing a liquid crystal display, comprising:
qualifying a chemical solution for use in manufacture of a liquid crystal display by using a qualification method cited in claim 1; and
manufacturing the liquid crystal display by using the qualified chemical solution.
